(19) United States
(12) Patent Application Publication
(10) Pub. No.: US 2012/0105881 A1
(43) Pub. Date: May 3, 2012

(54) IMAGE FORMING APPARATUS FOR PERFORMING IMAGE CONTROL ACCORDING TO TARGET VALUE

(75) Inventor: Hideaki Fukaya, Shizuoka (JP)

(73) Assignees: Toshiba Tec Kabushiki Kaisha, Tokyo (JP); Kabushiki Kaisha Toshiba, Tokyo (JP)

(21) Appl. No.: 13/285,317

(22) Filed: Oct. 31, 2011

Related U.S. Application Data
(60) Provisional application No. 61/409,933, filed on Nov. 3, 2010.

(51) Int. Cl. H04N 1/60

(52) U.S. Cl. 358/1.9

(57) ABSTRACT

An image forming apparatus includes: an image forming section configured to form a toner image on an image bearing member; and a first control section configured to change an image target value of the image forming section.

### CROSSREFERENCE TO RELATED APPLICATION

This application is based upon and claims the benefit of priority from Provisional U.S. Application 61/409,933 filed on Nov. 3, 2010 the entire contents of which are incorporated herein by reference.

### FIELD

Embodiments described herein relate generally to an image forming apparatus that obtains a printed image having image quality demanded by a user.

### BACKGROUND

Among image forming apparatuses such as a copying machine and a printer, there is an apparatus that performs

image control as appropriate in order to realize stability of the quality of an output image. However, if the apparatus is given versatility and the image control is performed, it is likely that images matching the purposes of use of various users and meeting demands of the users cannot be obtained with stable quality. Further, if the same printed image is continuously printed, it is likely that fluctuation in image quality of prints cannot be suppressed and image quality meeting a demand of a user cannot be maintained from the start to the end of the printing.

### BRIEF DESCRIPTION OF THE DRAWINGS

FIG. 1 is a schematic diagram of an image forming system according to an embodiment;

FIG. 2 is a schematic diagram of a MFP according to the embodiment;

FIG. 3 is a schematic diagram of a part of a printer section and a schematic block diagram of a control system mainly for image quality maintenance control of the MFP;

FIG. 4 is a diagram for explaining the principle of a toner deposit sensor according to the embodiment;

FIG. 5 is a flowchart for explaining image self-check according to the embodiment:

FIG. 6 is a diagram for explaining a test pattern according to the embodiment;

FIG. 7 is a flowchart for explaining an image automatic measurement processing before printing execution according to the embodiment;

FIG. 8 is a flowchart for explaining details of the image automatic measurement processing before printing execution according to the embodiment;

FIG. 9 is a diagram for explaining a setting update screen (of a display screen) according to the embodiment;

FIG. 10 is a diagram for explaining a trial completion screen (of the display screen) according to the embodiment;

FIG. 11 is a diagram for explaining a manual setting screen (of the display screen) according to the embodiment;

FIG. 12 is a diagram for explaining a condition update screen (of the display screen) according to the embodiment;

FIG. 13 is a diagram for explaining a call screen (of the display screen) according to the embodiment;

FIG. 14 is a diagram for explaining a template screen (of the display screen) according to the embodiment;

FIG. 15 is a diagram for explaining a detail setting screen (of the display screen) according to the embodiment;

FIG. 16 is a graph of an image of image density fluctuation of the MFP according to the embodiment; and

FIG. 17 is a graph of an image of image density fluctuation of an image forming apparatus according to a comparative example.

### DETAILED DESCRIPTION

In general, according to one embodiment, an image forming apparatus includes: an image forming section configured to form a toner image on an image bearing member; and a first control section configured to change an image target value of the image forming section.

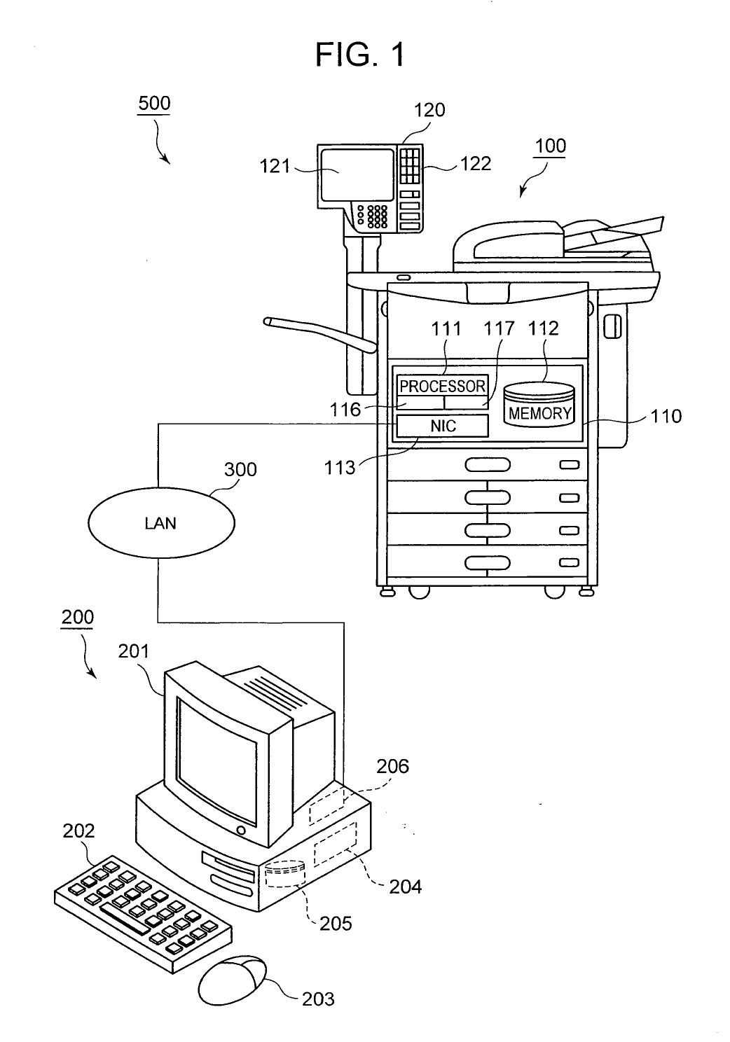

An embodiment is explained below. FIG. 1 is a diagram of an image forming system 500 according to the embodiment. The image forming system 500 includes a color MFP (Multi Functional Peripheral) 100, which is an image forming apparatus, and a user terminal 200. A LAN (Local Area Network) 300 connects the MFP 100 and the user terminal 200. The MFP 100 and the user terminal 200 respectively include communication functions and communicate with each other.

A control board 110 in the MFP 100 includes a processor 111, a memory 112, and a NIC (Network Interface Card) 113. The processor 111 also serves as a first control section and a second control section and includes a CPU 116 and a control circuit 117 configured to control the entire MFP 100. The memory 112 includes, for example, a RAM (Random Access Memory), a ROM (Read Only Memory), and a HDD (Hard disk drive). The NIC 113 controls communication with the outside. The MFP 100 includes a control panel 120. The control panel 120 includes, for example, a keyboard 122 configured to receive an instruction by a user and a touch panel display 121 configured to display control content and receive an instruction by the user or the like.

The user terminal 200 includes a processor 204, a memory 205, and a NIC (Network Interface Card) 206. The memory 205 includes, for example, a RAM (Random Access Memory), a ROM (Read Only Memory), and a HDD (Hard disk drive). The user terminal 200 includes, for example, a keyboard 202 configured to receive an input from the user, a mouse 203, and a monitor 201 configured to display control content and the like to the user. The user terminal 200 may be, for example, a personal computer. The NIC 113 and the NIC 206 perform communication control with each other via the LAN 300.

The MFP 100 includes a copy function, a printer function, a scanner function, a facsimile function, and a network communication function. For example, the MFP 100 functions as a network printer and executes printing requested from the user terminal 200.

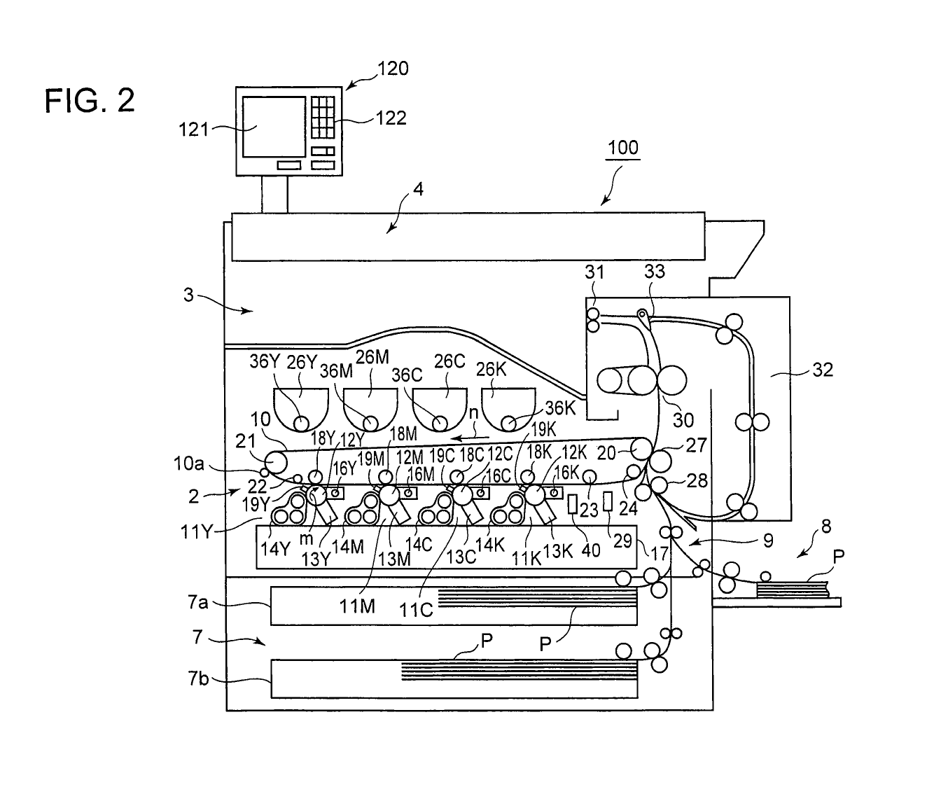

The configuration of the MFP 100 is explained below. As shown in FIG. 2, the MFP 100 includes, for example, a printer section 2, which is an image forming section configured to form an image, a paper discharge section 3 configured to accumulate a sheet P discharged from the printer section 2, a scanner section 4 configured to read a document image, a paper feeding device 7 configured to feed the sheet P, and a manual paper feeding device 8.

The printer section 2 includes four image forming stations 11Y, 11M, 11C, and 11K for Y (yellow), M (magenta), C (cyan), and K (black) arranged in parallel along the lower side of a transfer belt 10. The image forming stations 11Y, 11M, 11C, and 11K respectively include photoconductive drums 12Y, 12M, 12C, and 12K, which are image bearing members. The image forming stations 11Y, 11M, 11C, and 11K respectively form toner images of Y (yellow), M (magenta), C (cyan), and K (black) on the photoconductive drums 12Y, 12M, 12C, and 12K.

The image forming stations 11Y, 11M, 11C, and 11K respectively include, around the photoconductive drums 12Y, 12M, 12C, and 12K rotating in an arrow m direction, chargers 13Y, 13M, 13C, and 13K, developing devices 14Y, 14M, 14C, and 14K, photoconductive cleaners 16Y, 16M, 16C, and 16K, and drum thermistors 19Y, 19M, 19C, 19K.

A laser exposing device 17 irradiates exposure lights respectively corresponding to the colors on sections between the chargers 13Y, 13M, 13C, and 13K and the developing devices 14Y, 14M, 14C, and 14K around the photoconductive drums 12Y, 12M, 12C, and 12K. Electrostatic latent images are formed on the photoconductive drums 12Y, 12M, 12C, and 12K by the irradiation of the exposure lights from the laser exposing device 17.

The developing devices 14Y, 14M, 14C, and 14K respectively supply toners to the electrostatic latent images on the photoconductive drums 12Y, 12M, 12C, and 12K to visualize the electrostatic latent images. The developing devices 14Y, 14M, 14C, and 14K respectively develop the electrostatic latent images using two-component developers including toners of Y, M, C, or K and carriers.

The printer section 2 includes, above the developing devices 14Y, 14M, 14C, and 14K, toner cartridges 26Y, 26M, 26C, or 26K configured to respectively store developers of Y, M, C, or K supplied to the developing devices 14Y, 14M, 14C, and 14K. The toner cartridges 26Y, 26M, 26C, and 26K respectively include toner augers 36Y, 36M, 36C, and 36K configured to carry the toners to the developing devices 14Y, 14M, 14C, or 14K.

The transfer belt 10 is stretched and suspended among a backup roller 20, a driven roller 21, and first to third tension rollers 22 to 24 and rotate in an arrow n direction. The transfer belt 10 is opposed to and in contact with the photoconductive drums 12Y, 12M, 12C, and 12K. The printer 2 includes primary transfer rollers 18Y, 18M, 18C, and 18K in positions opposed to the photoconductive drums 12Y, 12M, 12C, and 12K. The primary transfer rollers 18Y, 18M, 18C, and 18K respectively primarily transfer toner images formed on the photoconductive drums 12Y, 12M, 12C, and 12K onto the transfer belt 10. The photoconductive cleaners 16Y, 16M, 16C, and 16K respectively remove and collect the residual toners on the photoconductive drums 12Y, 12M, 12C, and 12K after the primary transfer.

A toner deposit sensor 29, which is a detecting section, is provided downstream of the image forming station 11K for black (K) around the transfer belt 10. The toner deposit sensor 29 detects, for each color component, a test pattern for image density measurement generated on the transfer belt 10 and uses a detection result for correction of image densities of the image forming stations 11Y, 11M, 11C, and 11K. A temperature and humidity sensor 40 configured to measure the temperature and the humidity in a body of the MFP 100 is provided around the image forming station 11K for black (K).

A secondary transfer roller 27 is opposed to a secondary transfer section supported by the backup roller 20 of the transfer belt 10. In the secondary transfer section, predetermined secondary transfer bias is applied between the backup roller 20 and the secondary transfer roller 27. In the secondary transfer section, the toner images on the transfer belt 10 are collectively secondarily transferred onto the sheet P passing between the transfer belt 10 and the secondary transfer roller 27. The sheet P is fed from paper feeding cassettes 7a and 7b or the manual paper feeding device 8 to a space between the transfer belt 10 and the secondary transfer roller 27 by a conveying section 9 via a registration roller pair. A belt cleaner 10a cleans the transfer belt 10 after the end of the secondary transfer.

The printer section 2 includes a fixing device 30 further downstream than the secondary transfer roller 27 along a conveying direction of the sheet P. The fixing device 30 fixes, on the sheet P, the toner images secondarily transferred onto the sheet P from the transfer belt 10. The printer section 2 includes, downstream of the fixing device 30, a gate 33 configured to divert the sheet P in the direction of a paper discharge roller 31 or the direction of a re-conveying unit 32. The paper discharge roller 31 discharges the sheet P to the paper discharge section 3. The re-conveying unit 32 leads the sheet P in the direction of the secondary transfer roller 27 again.

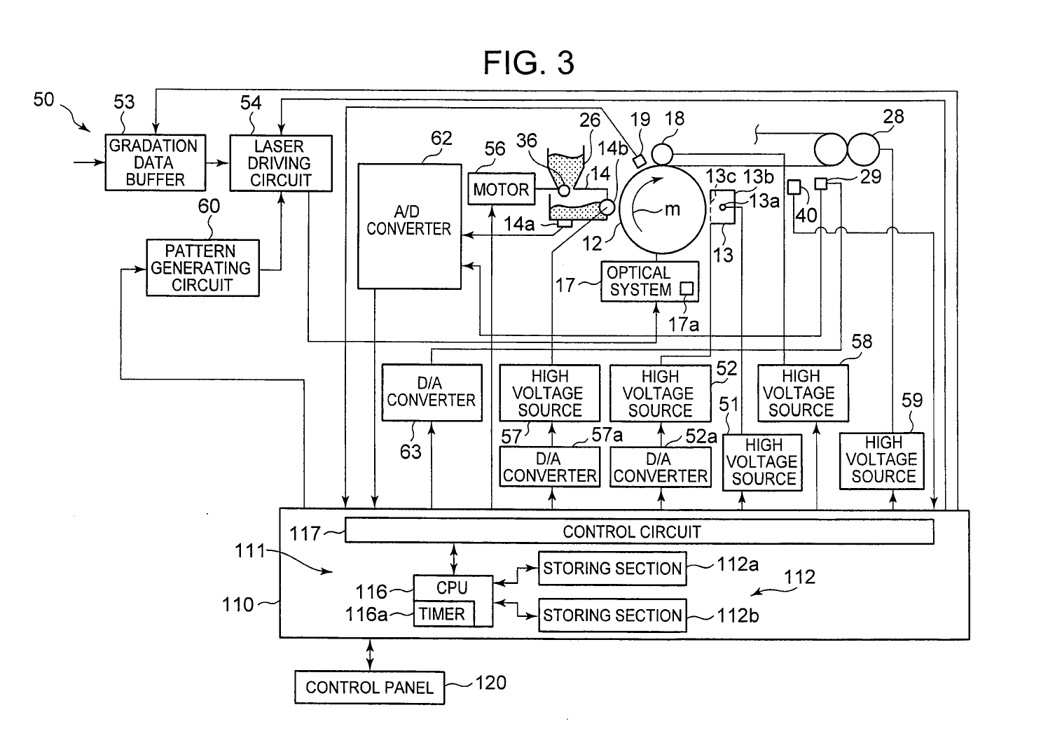

The printer section 2 is subjected to image control by a control system 50 shown in FIG. 3. The image forming stations 11Y, 11M, 11C, and 11K of the MFP 100 have the same structure, although the colors of the developers are different. Components of the image forming stations 11Y, 11M, 11C, and 11K are explained using common reference numerals and signs with reference to FIG. 3. The control system 50 is controlled by the control circuit 117 controlled by the CPU 116. The CPU 116 includes a timer 116a configured to measure standby time and the like and is connected to the memory 112 and the control panel 120. The CPU 116 is connected to the user terminal 200 via the NIC 113 and the LAN 300.

The charger 13 of the MFP 100 includes, for example, a charging wire 13a, a conductive case 13b, and a grid electrode 13c. The charging wire 13a is connected to a high voltage source 51 for a wire. The charging wire 13a performs corona discharge and uniformly charges the surface of the photoconductive drum 12. The grid electrode 13c is connected to a high voltage source 52 for a grid. A grid bias voltage of the grid electrode 13c controls a charging amount on the surface of the photoconductive drum 12. The drum thermistor 19 detects the temperature of the photoconductive drum 12 and inputs the temperature to the CPU 116. The temperature and humidity sensor 40 detects the temperature and the humidity in the body of the MFP 100 and inputs the temperature and the humidity to the CPU 116.

On the photoconductive drum 12 uniformly charged by the charger 13, electrostatic latent images are formed by irradiation of exposure lights from the laser exposing device 17. A gradation data buffer 53 stores, for example, gradation data input from the control panel 120 or the user terminal 200, corrects a gradation characteristic of the printer section 2, and converts the gradation data into laser exposure time data (pulse width data).

A laser driving circuit 54 modulates a laser driving current (a light emitting time) in synchronization with scanning positions of the exposure lights of the laser exposing device 17 and according to the laser exposure time data from the gradation data buffer 53. The laser driving circuit 54 drives a semiconductor laser oscillator 17a in the laser exposing device 17 with the modulated laser driving current (the light emitting time). The semiconductor laser oscillator 17a oscillates a laser beam according to the laser exposure time data. The laser driving circuit 54 controls an output light amount of the semiconductor laser oscillator 17a with the laser driving current (the light emitting time) in comparison with a light emitting element for monitor (not shown) in the laser exposing device 17. The control circuit 117 controls the gradation data buffer 53 and the laser driving circuit 54.

The developing device 14 measures toner density of a developer with a toner densitometer 14a. A motor 56 drives the toner auger 36 of the toner cartridge 26 according to an output of the toner densitometer 14a. The motor 56 drives the toner auger 36 to supply the toner in the toner cartridge 26 to the developing device 14.

A developing roller 14b of the developing device 14 is connected to a high voltage source 57 for development bias. The developing roller 14b rotates with development bias applied thereto by the high voltage source 57, deposits the toner on the electrostatic latent image on the photoconductive drum 12, and visualizes the electrostatic latent image.

The primary transfer roller 18 is connected to a high voltage source 58 for primary transfer. The secondary transfer roller 27 is connected to a high voltage source 59 for secondary transfer. The primary transfer roller primarily transfers a toner image on the photoconductive drum 12 onto the transfer belt 10. The toner image on the transfer belt 10 is secondarily transferred onto the sheet P passing between the transfer belt 10 and the secondary transfer roller 27.

The control circuit 117 controls the high voltage source 51, the high voltage source 58, and the high voltage source 59. The control circuit 117 supplies output voltage control signals respectively to the high voltage source 52 and the high voltage source 57 via a D/A converter 52a and a D/A converter 57a and controls the high voltage source 52 and the high voltage source 57.

The control system 50 includes a pattern generating circuit 60 for forming a test pattern on the transfer belt with the image forming station 11. The pattern generating circuit 60 is controlled by the control circuit 117 and generates pattern data, for example, at the end of warm-up of the printer section 2 after a power supply for the MFP 100 is turned on. The pattern generating circuit 60 inputs, for example, pattern data for controlling image density of a toner image to the laser driving circuit 54. The laser driving circuit 54 outputs a laser driving current to the laser exposing device 17 on the basis of the pattern data generated by the pattern generating circuit 60 and gradation data from the gradation data buffer 53. The laser exposing device 17 exposes a gradation pattern on the photoconductive drum 12.

After developing the gradation pattern on the photoconductive drum 12, the image forming station 11 primarily transfers the gradation pattern onto the transfer belt 10 and forms a test pattern on the transfer belt 10. The toner deposit sensor 29 detects the test pattern on the transfer belt 10.

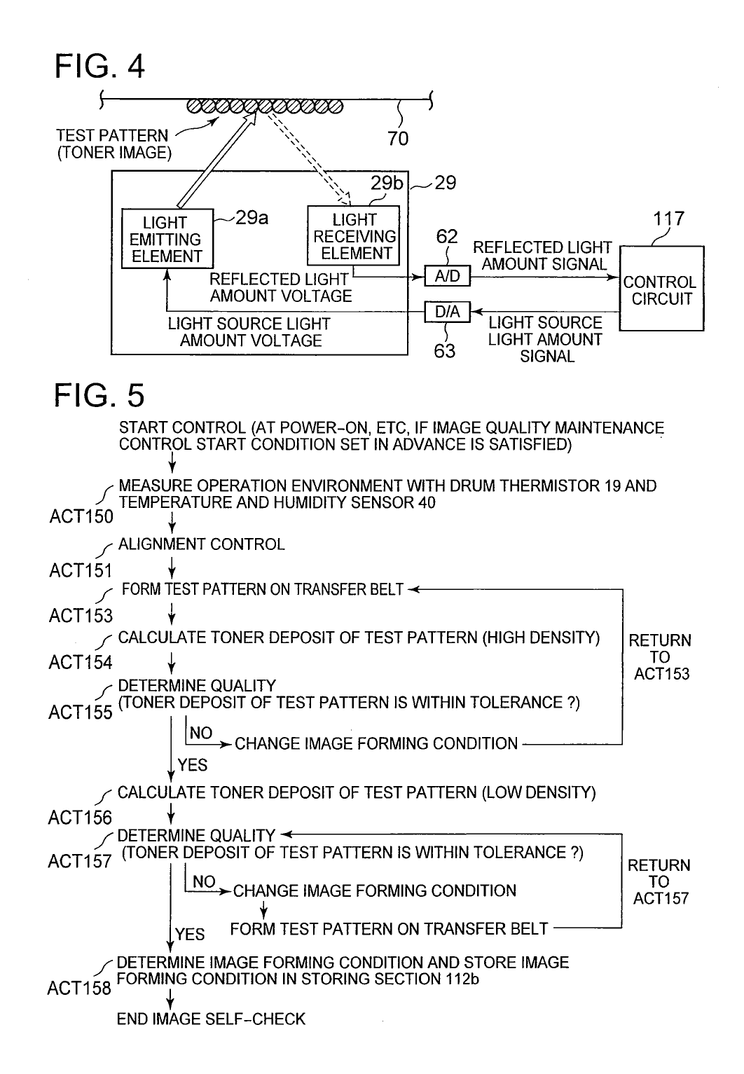

As shown in FIG. 4, the toner deposit sensor 29 includes a light emitting element 29a and a light receiving element 29b. A D/A converter 63 for a sensor controlled by the control circuit 117 of the control system 50 inputs, to the light emitting element 29a, a light source light amount voltage obtained by D/A-converting a light source light amount signal supplied from the control circuit 117. The light emitting element 29a projects light corresponding to the light source light amount voltage on the transfer belt 10 and a test pattern 70 formed on the transfer belt 10. The light receiving element 29b outputs a reflected light amount voltage to an A/D converter 62 for a sensor of the control system 50 according to a light amount of reflected light received from the test pattern 70. The A/D converter 62 A/D-converts the reflected light amount voltage from the light receiving element 29b and inputs the reflected light amount voltage to the control circuit 117 as a reflected light amount signal.

The CPU 116 calculates, from a received light amount of the A/D converter 62, for example, a voltage value of an output voltage to the high voltage source 52 and the high voltage source 57 such that a toner image formed on the image forming station 11 has appropriate image density. The control circuit 117 controls, according to the control from the CPU 116 based on a calculation result for the toner image to obtain appropriate image density, for example, an output voltage control signal to the high voltage source 52 and the high voltage source 57 and controls the image forming station 11.

If the image forming station 11 is subjected to feedback control, the CPU 116 repeats the detection of the test pattern by the toner deposit sensor 29 and the control of the output voltage control signal based on a detection result until toner density reaches the appropriate image density. If the image forming station 11 is subjected to expected correction control, the CPU 116 detects a test pattern once with the toner deposit sensor 29, calculates a difference between target image density, which is a target value of image density, and detected density using parameters, and controls the output voltage control signal on the basis of the calculation result. In the case of the expected correction control, the CPU 116 does not check whether the toner density reaches the appropriate image density.

The memory 112 includes a rewritable storing section 112a including an EEPROM in which data is not erased even if the power supply for the MFP 100 is turned off and a storing section 112b including an SRAM for data storage. Various setting values are stored in advance in the rewritable storing section 112a. The storing section 112a stores, for example, a target value at factory shipment, which is one of target values and is a reference value of an image of the printer section 2. The target value at factory shipment for image quality maintenance control is, for example, target image density (a toner deposit target value) set as a target of an image formed by the MFP 100 during factory shipment.

The storing section 112a stores, for example, an initial grid bias voltage value and a development bias voltage value corresponding to a bias condition, which is a reference gradation characteristic at normal temperature and normal humidity, test pattern gradation data, a coefficient representing a surface potential characteristic, a predetermined number of prints, a predetermined elapsed time, a maximum number of times of control, bias condition values, an abnormal range of the toner deposit sensor 29, a reflected light amount in an area other than a test pattern area, and parameters used for the calculation in the expected correction control.

The bias condition values are, for example, tolerances of upper limit values and lower limit values of the high voltage source 52 for a grid and the high voltage source 57 for development bias and a tolerance of a difference in a voltage between grid bias and development bias. The parameters of the expected correction control are correction amount coefficients of the grid bias by the high voltage source 52 and the development bias by the high voltage source 57 corresponding to temperature and humidity, toner density of a developer measured by the toner densitometer 14a, and a degree of deterioration of consumables.

For example, the user can change an image target value output by the MFP 100 from the target value at factory shipment stored by the storing section 112a to a user target value, which is a new target value. In order to obtain a desired image, the user inputs data from, for example, the control panel 120 and resets the image target value to the user target value. The user target value is target image density (a toner deposit target value) set as a target by the user. The MFP 100 stores the reset user target value in, for example, the storing section 112b. The user can also store the user target value in, for example, an external storing section.

If a user target value same as that stored in the storing section 112b is stored in the storing section 112a, in which data is not erased even if the power supply for the MFP 100 is turned off, it is also possible to call and use a previous user target value without using an external storage during the reset. The user performs the reset of the user target value by inputting data from, for example, the control panel 120 or the user terminal 200. The user target value can be displayed on the touch panel display 121, the monitor 201, and the like.

Since the MFP 100 superimposes toner image of the four colors Y, M, C, and K to form a color image, the MFP 100 needs image control for the toner images of the four colors in order to keep image quality. In the MFP 100, a shift occurs among the toner images of the four colors because of fluctuation in an operation environment due to temperature fluctuation in the photoconductive drums 12Y, 12M, 12C, and 12K and fluctuation in environment characteristics on the inside of the MFP 100 or fluctuation in aging characteristics of the photoconductive drums 12Y, 12M, 12C, and 12K.

The MFP 100 periodically performs the image control concerning the four colors of Y, M, C, and K in order to keep image quality even if the operation environment or the aging characteristics fluctuate. As the image control, the MFP 100 performs, for example, image quality maintenance control for performing gradation correction and density correction for the toner images of the four colors and alignment control for adjusting the positions of the toner images of the four colors.

For the image control, the MFP 100 performs, if necessary, image automatic measurement processing, which is image control for setting a user target value reset by the user as a target of an image, besides image self-check, which is image control for setting the target value at factory shipment as the image target value. In this embodiment, the image control is explained in detail using the image quality maintenance control as an example in both the image self-check and the image automatic measurement processing. However, the image control is not limited to the image quality maintenance control.

During the warm-up after the power supply is turned on and if a start condition for the image quality maintenance control set in advance is satisfied, the MFP 100 performs the image self-check shown in FIG. 5. For example, during the warm-up, the MFP 100 measures an operation environment from detection results of the drum thermistor 19 and the temperature and humidity sensor 40 (ACT 150).

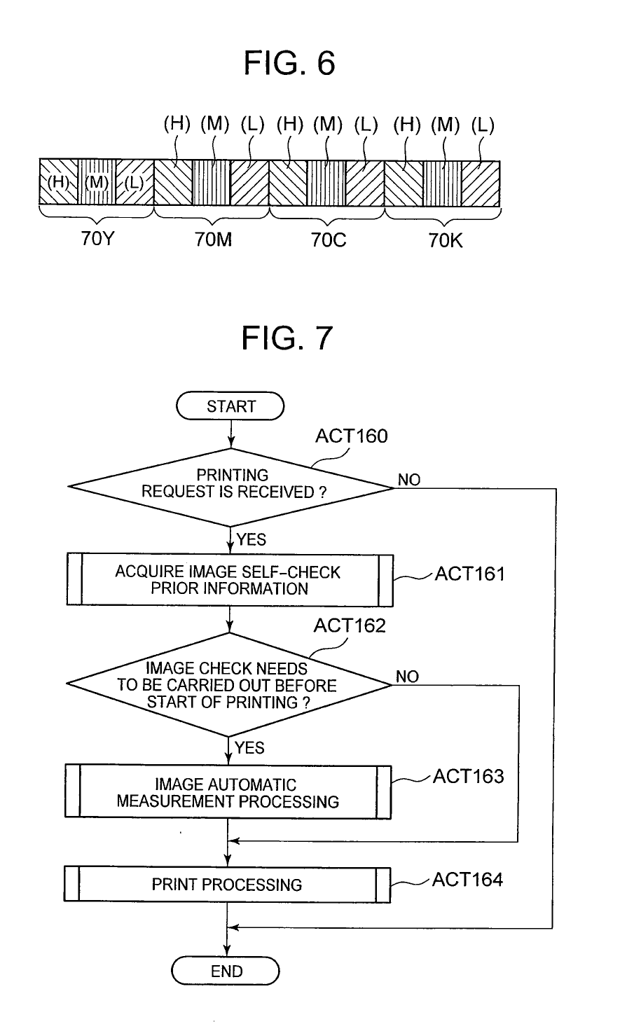

Subsequently, after the alignment control (ACT 151), the MFP 100 performs the image quality maintenance control. In the image quality maintenance control, the MFP 100 controls the printer section 2 using the target value at factory shipment stored by the storing section 112a as target image density of an image formed by the MFP 100. According to the start of the image quality maintenance control, the image forming station 11 forms for example, the test pattern 70 shown in FIG. 6 on the transfer belt (ACT 153).

The test pattern 70 includes patterns 70Y, 70M, 70C, and 70K of the four colors Y, M, C, and K arrayed on one straight line in a main scanning direction of the transfer belt 10 for each color component. The image forming station 11 sets output voltage values of the high voltage source 52 and the high voltage source 57, based on an image forming condition for setting the target value at factory shipment as target image density of an image and forms the patterns 70Y, 70M, 70C, and 70K of the four colors. The patterns 70Y, 70M, 70C, and 70K include density areas of high density (H), medium density (M), and low density (L) for each color component.

The toner deposit sensor 29 detects a toner deposit for each color component with respect to the patterns 70Y, 70M, 70C, and 70K of the four colors and inputs the toner deposit to the CPU 116. The CPU 116 calculates a toner deposit of high density (H) for each color component of the test pattern 70 (ACT 154). The CPU 116 determines whether the toner deposit of high density (H) of the test patter 70 is within a tolerance of the high density target value at factory shipment (ACT 155). The tolerance of the high density target value means a range of a passing mark of high density between an upper limit and a lower limit of the tolerance of the high density target value.

If the toner deposit is not within the tolerance (No in ACT 155), the CPU 116 changes the image forming condition for controlling an output voltage to the high voltage source 52 and the high voltage source 57 and returns to ACT 153. If the toner deposit is within the tolerance (Yes in ACT 155), the CPU 116 calculates a toner deposit of low density (L) for each color component of the test pattern 70 (ACT 156).

The CPU 116 determines whether the toner deposit of low density (L) of the test pattern 70 is within the tolerance of a low density target value at factory shipment (ACT 157). The tolerance of the low density target value means a range of a passing mark of low density between an upper limit and a lower limit of the tolerance of the low density target value.

If the toner deposit is not within the tolerance (No in ACT 157), the CPU 116 changes the image forming condition for controlling an output voltage to the high voltage source 52 and the high voltage source 57 and, after forming the test pattern 70 on the transfer belt 10, returns to ACT 157. If the toner deposit is within the tolerance (Yes in ACT 157), the MFP 100 determines, as image forming conditions, an output voltage to the high voltage source 52 and the high voltage source 57 and a control parameter of the gradation data buffer 53 for causing the laser driving circuit 54 to modulate a laser driving current and stores the output voltage and the control parameter in the storing section 112b for data storage (ACT 158) and ends the image self-check.

After ending the image self-check, if there is a printing request, the MFP 100 performs the image automatic measurement processing before executing printing. As shown in FIG. 7, if a printing request is received from the control panel 120, the user terminal 200, or the like (Yes in ACT 160), the MFP 100 acquires prior information concerning the image self-check (ACT 161). The user determines from the prior information whether it is necessary to carry out image check before starting printing (ACT 162).

If the image check by the user is unnecessary (No in ACT 162), the MFP 100 sets, without performing the image automatic measurement processing by user setting, the target value at factory shipment as a target image density and executes printing of a job for which the printing request is received (Act 164). While executing printing in ACT 164, the MFP 100 performs the image quality maintenance control. As the image quality maintenance control, the MFP 100 performs, rather than the feedback control, the expected correction control for calculating a difference between the target image density of the target value at factory shipment and image density detected by the toner deposit sensor 29. The MFP 100 carries out the expected correction control at a paper interval such as a paper interval of mass printing or a break of the number of copies or a paper interval when a change in an image forming condition occurs such as a change from plain paper to thick paper.

If the image check by the user is necessary (Yes in ACT 162), the MFP 100 performs the image automatic measurement processing according to user setting (ACT 163). If image quality demanded by the user is not obtained under the image forming condition in which the target value at factory shipment is set as the image target value, the user determines in ACT 162 that the image check is necessary. The MFP 100 performs the image automatic measurement processing in ACT 163 and, in order to obtain the image quality demanded by the user, resets the image target value as a user target value.

The MFP 100 changes the image target value to the user target value in ACT 163 and controls, for the image quality maintenance control, the output voltage to the high voltage source 52 and the high voltage source 57 and the control parameter of the gradation data buffer 53 for causing the laser driving circuit 54 to modulate a laser driving current. After controlling the image forming condition for changing the image target value to the user target value in ACT 163, the MFP 100 executes printing of the job for which the printing request is received (ACT 164). While executing the printing in ACT 164, at desired timing, the MFP 100 performs, as the image quality maintenance control, the expected correction control for calculating a difference between the target image density of the user target value and the image density detected by the toner deposit sensor 29.

The CPU 116 calculates, using the control parameter, an output voltage value to the high voltage source 52 and the high voltage source 57 to bring image density of an image output by the MFP 100 close to the target image density at factory shipment or the user target image density. The CPU 116 reduces time required for the image quality maintenance control by subjecting the output voltage value to the high voltage source 52 and the high voltage source 57 to the expected correction processing rather than the feedback control.

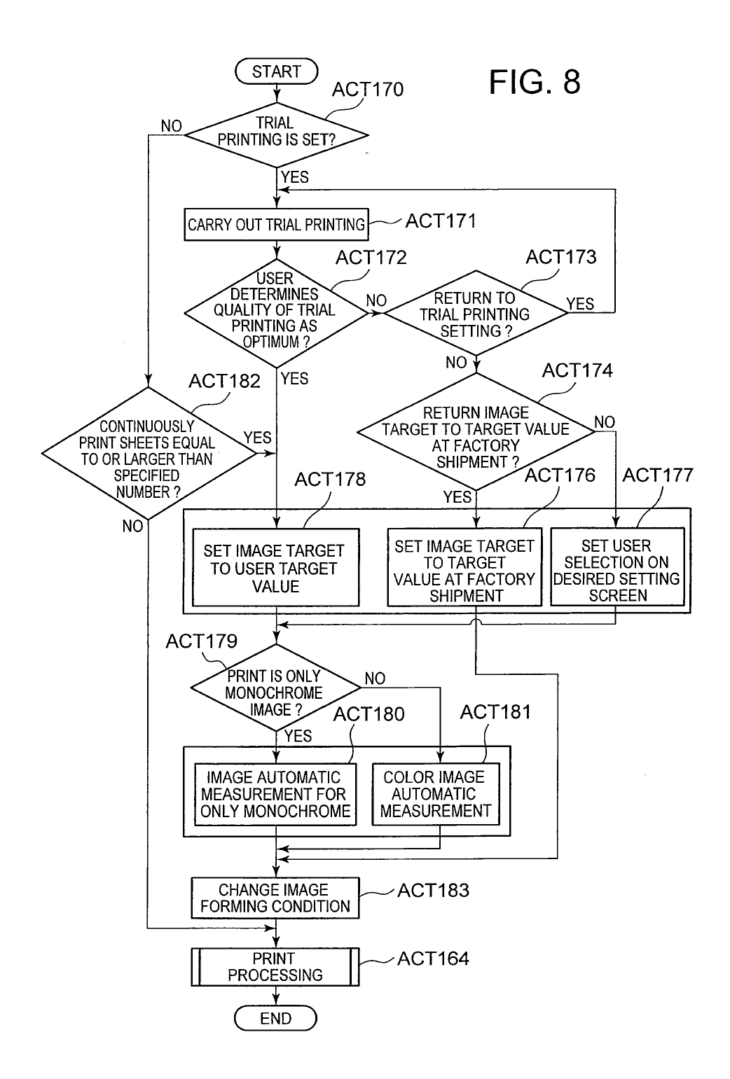

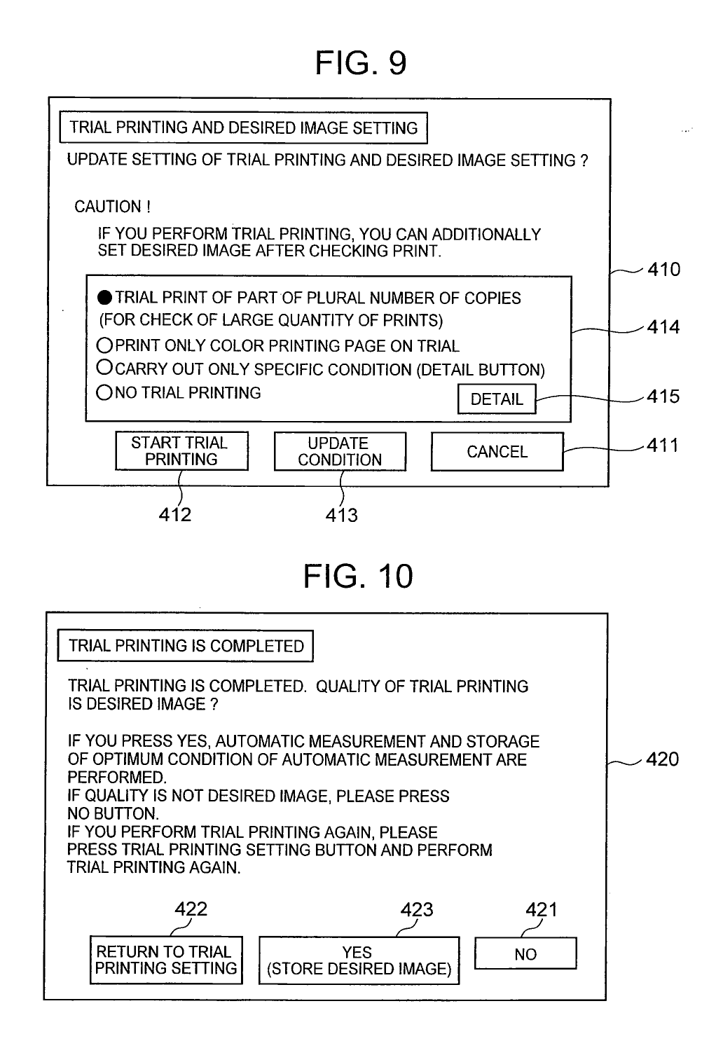

The image automatic measurement processing in ACT 163 is explained in detail. In the image automatic measurement processing in ACT 163, as shown in FIG. 8, the CPU 116 determines whether the user sets trial printing (ACT 170). If the printing request is received in ACT 160, the touch panel display 121 or the monitor 201 (hereinafter abbreviated as display screen) displays, for example, a setting update screen 410 shown in FIG. 9. If the trial printing is unnecessary, the user selects cancel 411 of the setting update screen 410 (No in ACT 170).

If the trial printing is performed, the user selects trial printing start 412 from the setting update screen 410 (Yes in ACT 170). For example, if the user outputs the same print in large quantities, the user uses the trial printing to check a finish state of an image only on one copy before actually starting printing. If the user selects the trial printing start 412, the MFP 100 carries out the trial printing for one copy and displays a trial completion screen 420, for example, shown in FIG. 10 on the display screen (ACT 171).

The user determines whether printing quality of a trial image obtained by the trial printing is satisfactory (ACT 172). If the printing quality of the trial image is unsatisfactory, the user selects “NO” 421 or “return to trial printing setting” 422 of the trial completion screen 420 (No in ACT 172). If the user selects the “NO” 421 or the “return to trial printing setting” 422, the MFP 100 determines whether the MFP 100 returns to the trial printing setting (ACT 173). If the user selects the “return to trial printing setting” 422 (Yes in ACT 173), the MFP 100 returns to ACT 171 and displays the setting update screen 410 on the display screen.

If the user selects the “NO” 421 (No in ACT 173), the display screen transitions from the trial completion screen 420 to a screen for returning the image target value to the target value at factory shipment (not shown). The user determines whether the image target value is returned to the target value at factory shipment (ACT 174). If the user selects Yes on the screen for returning the image target value to the target value at factory shipment (not shown) (Yes in ACT 174), the MFP 100 sets a parameter for image control to the target value at factory shipment and returns the control of the output voltage to the high voltage source 52 and the high voltage source 57 to the control for setting the target value at factory shipment as the image target value (ACT 176). Subsequently, the MFP 100 proceeds to ACT 183.

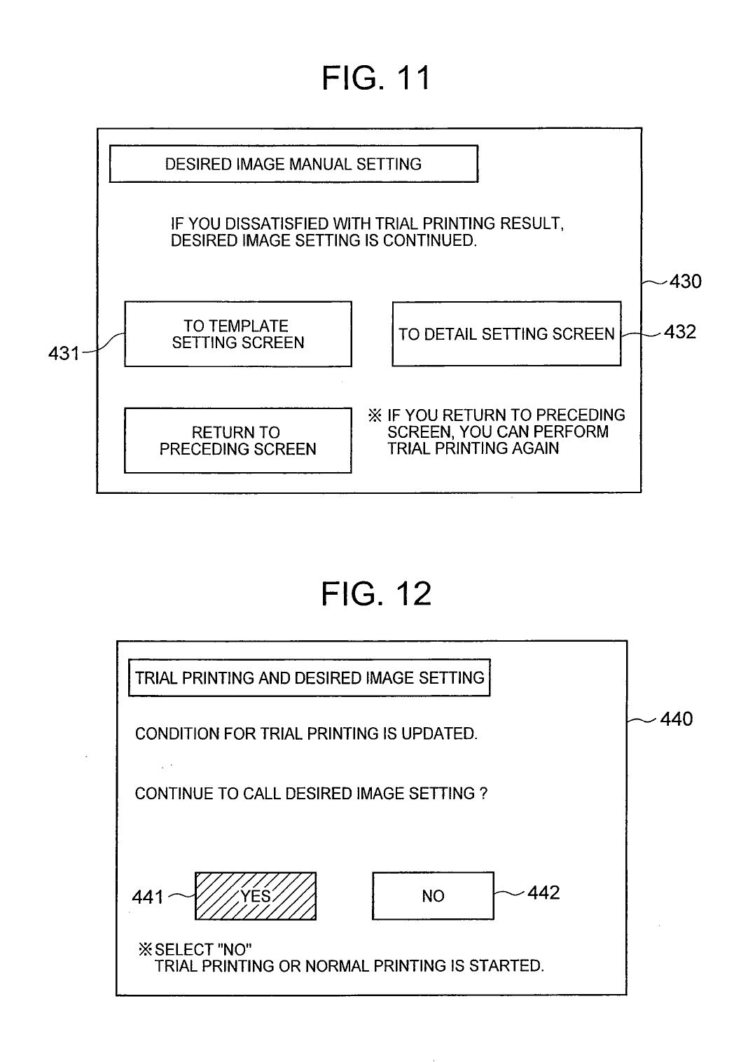

If the image target value is not returned to the target value at factory shipment, the user selects No on the screen for returning the image target value to the target value at factory shipment (not shown) (No in ACT 174). If the user selects No on the screen for returning the image target value to the target value at factory shipment (not shown), the display screen shift to, for example, a manual setting screen 430 shown in FIG. 11. The manual setting screen 430 indicates a screen for performing more detailed setting if the image obtained by the trial printing is not optimum.

According to an instruction from the manual setting screen 430 by the user, the MFP 100 forcibly carries out the image automatic measurement processing after calling desired image setting stored in the storing section 112a, automatically corrects a parameter concerning image control, and determines an optimum value (ACT 177). In ACT 177, the MFP 100 sets the parameter concerning image control according to selection by the user on the desired setting screen to further optimize the parameter. In ACT 177, the MFP 100 corrects, according to the selection by the user, for example, the output voltage value to the high voltage source 52 and the high voltage source 57 and the control parameter of the gradation data buffer 53 for causing the laser driving circuit 54 to modulate a laser driving current.

A state of the image set according to the selection by the user in ACT 177 is set as the user target value. The user target value can be stored in a user memory such as a HDD as user exclusive data in the user terminal 200. The user target value may be stored in the storing section 112a as data exclusively used by the user. The MFP 100 proceeds to ACT 179.

If the user is satisfied with the printing quality of the trial image in ACT 172 (Yes in ACT 172), the user selects “YES (desired image storage)” 423 of the trial completion screen 420. If the user selects the “YES (desired image storage)” 423, the MFP 100 sets a state of the image at the time of the printing of the trial image as the user target value (ACT 178). The user target value can be stored as user exclusive data in a user memory such as a HDD in the user terminal 200. The user target value may be stored in the storing section 112a as data exclusively used by the user. The MFP 100 proceeds to Act 179.

If the user target value is stored in the user memory and if the user thereafter gives another printing request to the MFP 100, the user can call the user exclusive data from the user memory owned by the user and execute a printing job using the user target value stored in the user exclusive data. If the user executes the printing job in the MFP 100 using the stored user target value, the user needs to cause the MFP 100 to recognize the user target value before executing the printing job.

On the other hand, if user authentication is performed from the control panel 120, the user terminal 200, or the like and the user can be specified, the user does not need to set the user target value every time. After the user authentication, the MFP 100 calls the user target value stored in the storing section 112a, in which the data exclusively used by the user is stored, or the user memory and executes the printing job. If the user target value stored in the storing section 112a, the user memory, or the like is called and used, the user can save labor and time for setting the user target value.

After setting the user target value in ACT 177 or ACT 178, if an image of the job for which the printing request is received is only a monochrome image (Yes in ACT 179), the MFP 100 automatically measures the solely monochrome image (ACT 180). In ACT 180, the MFP 100 stores the user target value concerning the image parameter of the monochrome image set in ACT 177 or ACT 178.

In order to store the user target value for monochrome in, for example, the user memory, the storing section 112a, and the storing section 112b in ACT 180, the MFP 100 generates a test pattern 70K of K (black) on the transfer belt 10 and measures the generated test pattern 70K with the toner deposit sensor 29. The measurement by the toner deposit sensor 29 only has to be performed once. The MFP 100 stores the density of the image measured by the toner deposit sensor 29 in the user memory, the storing section 112a, and the storing section 112b as the user target value and proceeds to ACT 183. In ACT 180, generation and measurement of test patterns 70Y, 70M, and 70C are not carried out.

If the image of the job which is the printing request is received is a color image (No in ACT 179), the MFP 100 automatically measures an image concerning color (ACT 181). In ACT 181, the MFP 100 stores the user target value of the color image set in ACT 177 or ACT 178. In order to store the user target value for color in, for example, the user memory, the storing section 112a, and the storing section 112b in ACT 181, the MFP 100 generates test patterns 70Y, 70M, 70C, and 70K on the transfer belt 10 and measures the generated test patterns 70Y, 70M, 70C, and 70K with the toner deposit sensor 29. The measurement by the toner deposit sensor 29 only has to be performed once. The MFP 100 stores the density of the image measured by the toner deposit sensor 29 in the user memory, the storing section 112a, and the storing section 112b as the user target value and proceeds to ACT 183.

In ACT 183, the CPU 116 changes the image forming condition of the MFP 100 to an image forming condition in which the user target value stored in ACT 180 or ACT 181 or the target value at factory shipment is set as a target. In ACT 183, the CPU 116 changes, according to the image forming condition, the output voltage to the high voltage source 52 and the high voltage source 57 and the control parameter of the gradation data buffer 53 for causing the laser driving circuit 54 to modulate a laser driving current.

Subsequently, the MFP 100 executes printing of the job for which the printing request is received (ACT 164). While executing the printing in ACT 164, the MFP 100 executes, at desired timing, as the image quality maintenance control, the expected correction control for setting the user target value or the target value at factory shipment as target image density.

If the trial printing is not set (No in ACT 170) and if the job for which the printing request is received is mass printing, the MFP 100 determines whether continuous printing is performed even if the number of prints is equal to or larger than a specified number of sheets set in advance (ACT 182). If the user selects the cancel 411 of the setting update screen 410, the display screen transitions from the setting update screen 410 to a continuous printing condition screen (not shown). The user selects on the continuous printing condition screen (not shown) whether the continuous printing is continued. If the user selects the continuation of the continuous printing (No in ACT 182), after acquiring prior information by the image self-check in ACT 161, the MFP 100 executes the printing of the job for which the printing request is received without performing prior processing (ACT 164).

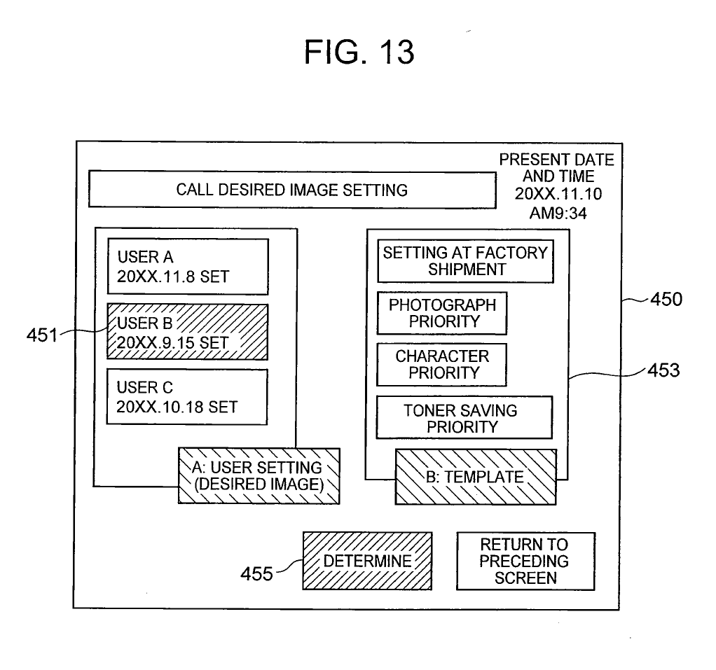

If the user selects to perform the image quality maintenance control at the user target value according to a screen shown in FIG. 13 (Yes in ACT 182), the MFP 100 proceeds to ACT 178. The MFP 100 executes the printing in ACT 164 through ACTS 178 to 181 and ACT 183 according to the user target value set in ACT 178. The MFP 100 acquires a printed image having image quality close to desired image quality of users.

If, in ACT 164, the MFP 100 completes the printing of the job for which the printing request is received, in a state in which user authentication is not performed, the user target value stored in the storing section 112b is deleted. If the printing job for which the printing request is received is completed, the image control of the MFP 100 for setting the user target value as the target image density is reset and is set to the image control for setting the target value at factory shipment as the target image density, which is set during the image self-check.

Operation by the user in selecting the trial printing start 412 of the setting update screen 410 in ACT 170 is explained in detail.

(1) Before selecting the trial printing start 412, the user selects an item of printing conditions 414 of the setting update screen 410 according to necessity. For example, if the trial printing of a monochrome image is unnecessary, the user selects “print only color printing page on trial” in the printing conditions 414. If a job for which the trial printing is requested is printing of only a monochrome image, the MFP 100 immediately starts printing without performing the trial printing. If the user changes the condition to “print only color printing page on trial”, if the job is printing of only a monochrome image, the MFP 100 does not carry out ACT 163. The user can save labor and time for checking the trial printing.

It is assumed that, after selecting “print only color printing page on trial” in the printing conditions 414, the user selects, for example, “only photograph mode” from a detail screen (not shown) displayed by selecting detail 415. If the user selects “only photograph mode” on the detail screen, even in the job for a color printing page, the MFP 100 does not perform the trial printing in modes other than a “photograph mode”. If the “photograph mode” is not included in the job, the MFP 100 does not carry out ACT 163 and immediately starts the printing.

An image mode of a job is determined as the photograph mode or only a monochrome image according to, for example, automatic determination by image analysis. Alternatively, the user can select and set the image mode of the job. The user selects image processing in the photograph mode or selects the image processing for only monochrome from the control panel 120 or the user terminal 200. The user can also select the image mode by selecting character and photograph modes or an automatic determination mode, monochrome and color modes, an auto color mode, and the like.

(2) Before selecting the trial printing start 412, the user updates an image condition from condition update 413 of the setting update screen 410 according to necessity. If the user selects the condition update 413 of the setting update screen 410, the display screen transitions from the setting update screen 410 to, for example, a condition update screen 440 shown in FIG. 12. If the user selects “Yes” 441 of the condition update screen 440, the MFP 100 displays a call screen 450, for example, shown in FIG. 13 on the display screen. If the user selects “No” 442 of the condition update screen 440, the MFP 100 completes all kinds of setting and starts, according to the setting by the user, the trial printing or the printing of the job for which the printing request is received.

On the call screen 450, for example, the user target value stored before is called or a template of desired image setting prepared to be set in advance is set. The user calls the user target value stored before from the user memory or the storing section 112a in which the data exclusively used by the user is stored. If the user target value is called from the storing section 112a, the user performs user authentication from the control panel 120 or the user terminal 200 in advance.

If the user selects user B setting 451 and then selects determine 455 on the call screen 450, the MFP 100 sets the user target value stored in at least any one of the storing section 112a, the storing section 112b, and the user memory as the target image density, controls the output voltage to the high voltage source 52 and the high voltage source 57, and starts the printing of the job for which the printing request is received. The check of the image in the trial printing by the user is unnecessary.

If the user selects a condition of a template group 453 and then selects the determine 455 on the call screen 450, the MFP 100 stores the selected condition in the storing section 112b or the like as the user target value (ACT 180 or ACT 181), controls, for example, the output voltage to the high voltage source 52 and the high voltage source 57 to obtain an image of the user target value, and starts the printing of the job for which the printing request is received.

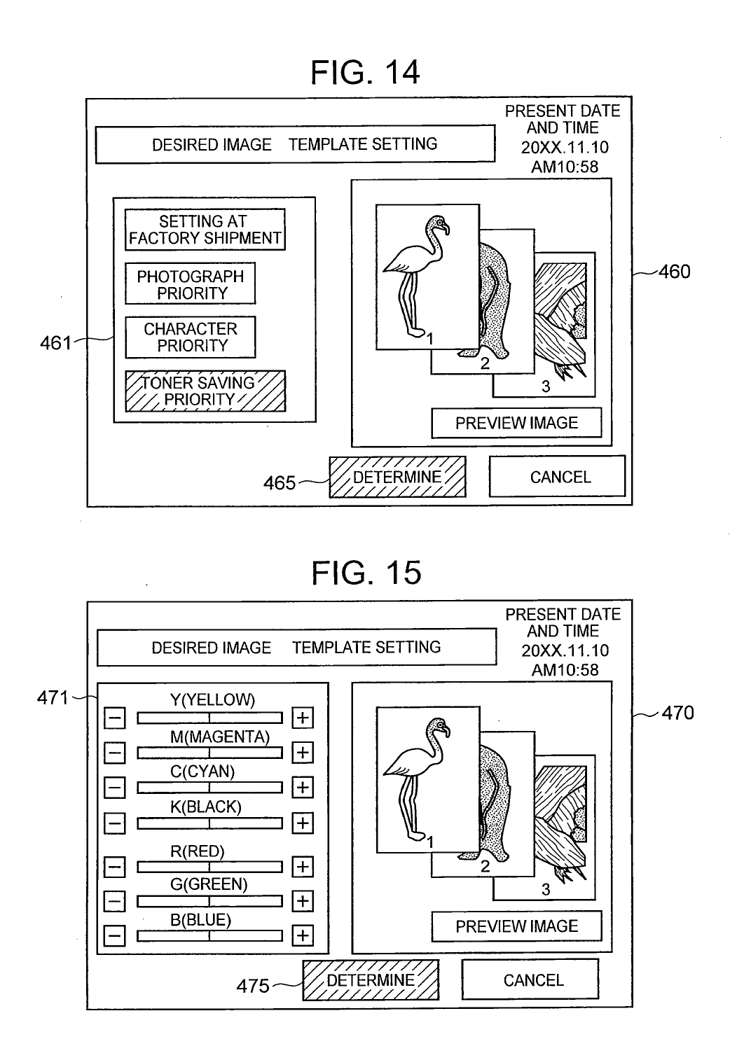

(3) If the user is not satisfied with the printing quality of the trial image and if the image target value is not returned to the target value at factory shipment (No in ACT 174), the manual setting screen 430 is displayed on the display screen. If the user selects “To template setting screen” 431 of the manual setting screen 430, the MFP 100 displays a template screen 460, for example, shown in FIG. 14. The MFP 100 previews an image before actual printing and simulates a change on the template screen 460. If the user select “toner saving priority” 461 on the template screen 460 and selects determine 465, the image is not set to be bright overall and is set to be pale in all colors. According to the setting from the template screen 460, the MFP 100 automatically changes the user target value, stores the user target value in the storing section 112b, and changes the target image density of an image formed by the MFP 100.

If the user selects “To detail setting screen” 432 of the manual setting screen 430, the MFP 100 displays a detail setting screen 470, for example, shown in FIG. 15. The MFP 100 previews an image before actual printing and simulates a change on the detail setting screen 470. If the user selects a condition of a density condition group 471 of the detail setting screen 470 and then selects determine 475, colors are adjusted according to the condition. According to the setting from the detail setting screen 470, the MFP 100 automatically changes the user target value, stores the user target value in the storing section 112b, and changes the target image density of an image formed by the MFP 100.

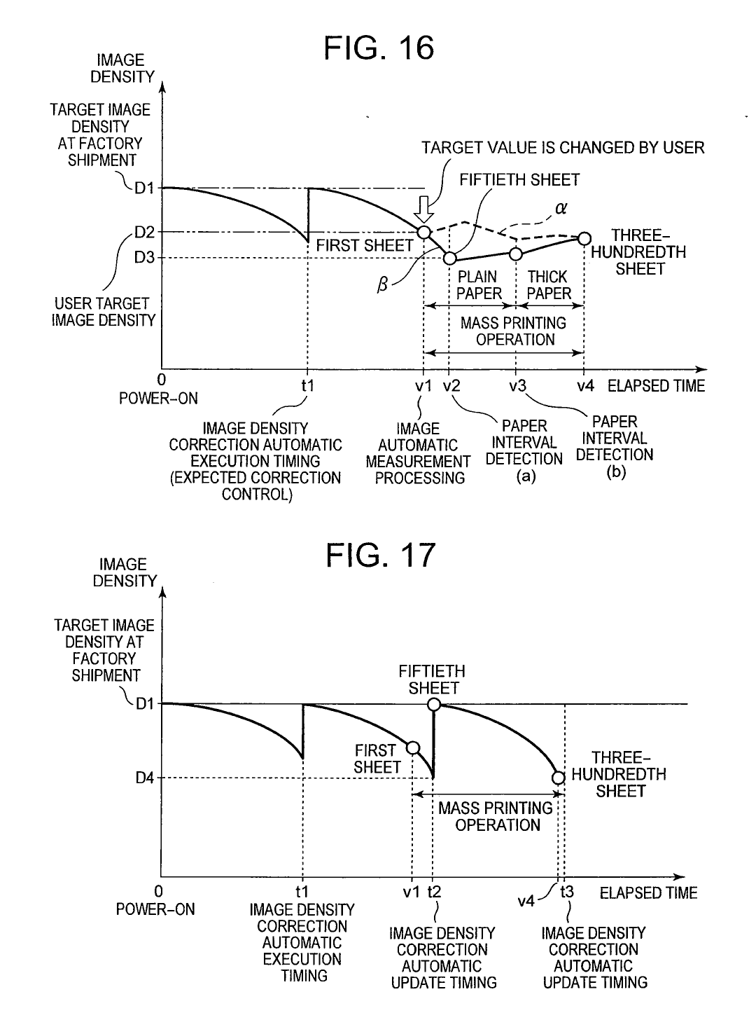

An image of image density fluctuation of a toner image obtained if the image automatic measurement processing is performed before printing execution, the image target value is changed from the target value at factory shipment to the user target value, and the image quality maintenance control is performed is shown in FIG. 16. The MFP 100 performs warm-up according to power-on. For example, at the end of the warm-up, the MFP 100 sets, through the image self-check, the target image density of the image quality maintenance control to target image density at factory shipment D1, which is the target value at factory shipment, and automatically performs the image quality maintenance control. In the image quality maintenance control, the MFP 100 sets, for example, the output voltage to the high voltage power supply 52 and the high voltage power supply 57. In the image self-check during the warm-up, the MFP 100 performs the image quality maintenance control according to the feedback control.

After the warm-up ends, when time set in advance elapses and image density correction automatic execution timing t1 comes, the MFP 100 sets the target image density to the target image density at factory shipment D1 and performs the expected correction control as the image quality maintenance control.

At timing v1, if the user carries out image check, for example, before execution of mass printing of 300 sheets, the MFP 100 performs the image automatic measurement processing. According to the image automatic measurement processing, the MFP 100 changes the target image density of the image quality maintenance control from the target value at factory shipment to the user target value. The MFP 100 sets the target image density to user target image density D2. Until the mass printing is completed, the MFP 100 sets the target image density to the user target image density D2 and performs the image quality maintenance control according to the expected correction control at selected timing. Concerning the timing for carrying out the image quality maintenance control, the MFP 100 carries out the image quality maintenance control at a paper interval such as a paper interval of mass printing or a break of the number of copies or a paper interval when a change in an image forming condition occurs such as a change from plain paper to thick paper.

For example, in paper interval detection (a) at timing v2 when printing of fifty sheets is completed from the start of printing, the MFP 100 generates the test pattern 70 on the transfer belt 10 once and measures the generated test pattern 70 with the toner deposit sensor 29. The MFP 100 performs the image quality maintenance control according to the expected correction control for calculating a difference between the user target image density D2 at the start of the printing and density measured by the toner deposit sensor 29.

For example, in paper interval detection (b) at timing v3 when the sheets of the mass printing are changed from plain paper to thick paper, the MFP 100 performs the image quality maintenance control according to the expected correction control for setting the target image density as the user target image density D2. At timing v4, the MFP 100 completes the mass printing of 300 sheets. Usually, for example, as indicated by a broken line α, a density change in image density after the image automatic measurement processing at timing v1 hardly occurs. The user target image density D2 is maintained.

If the difference between the density measured by the toner deposit sensor 29 and the user target image density D2 in the paper interval detection (a) at timing v2 is large, for example, as indicated by a solid line β, for example, a limit is set for a correction amount of a parameter of the calculation. The correction amount of the parameter is limited to reduce the difference stepwise. A sudden change of image density of an image printed by the MFP 100 is suppressed.

According to the limitation of the correction amount of the parameter, after timing v2, the image density by the MFP 100 gently approaches the user target image density D2. In the case of the solid line β, in the image quality maintenance control by the expected correction control in the paper interval detection (b), the MFP 100 sets a parameter correction amount taking into account, for example, in a detection result in the paper interval detection (b), a change in the image forming condition due to a change in paper quality. According to the expected correction control after timing v3, the image density by the MFP 100 gently approaches the user target image density D2. At timing v4, the MFP 100 completes the mass printing of 300 sheets.

According to the image automatic measurement processing, the MFP 100 changes the target image density from the target image density at factory shipment D1 to the user target image density D2 and obtains an image close to the request of the user. Since the MFP 100 detects a paper interval, the MFP 100 gently performs the expected correction control to suppress, for example, a color change in an image in the same print as much as possible. Since the MFP 100 sets the target image density at factory shipment D1 or the user target image density D2 as the target image density and performs the expected correction control, the MFP 100 reduces waiting time of the user for the image quality maintenance control.

For example, if a paper interval cannot be detected after the image automatic measurement processing at timing v1, it is likely that the printing is continued while the image automatic measurement processing setting at timing v1 is maintained while the mass printing is carried out from the start of the printing. If a paper interval cannot be detected and an amount of change of image density of a print is large with respect to the user target value, for example, in order to suppress a change in the image density, it is also possible to adjust high voltage output setting or the like to the user target value again by forcibly suspend the printing.

On the other hand, an image of image density fluctuation of a toner image obtained if the target image density is set to the target image density at factory shipment D1 and the image quality maintenance control is performed according to the image self-check at timing set in advance in an image forming apparatus according to a comparative example (not shown) is shown in FIG. 17. At the end of the warm-up after power-on, the image forming apparatus according to the comparative example sets the target image density at factory shipment D1 as the target image density and automatically performs image quality maintenance control according to the image self-check by the feedback control.

After the end of the warm-up, at image density correction automatic executing timings t1, t2, and the like set in advance, in the same manner as during the warm-up, the image forming apparatus according to the comparative example sets the target image density at factory shipment D1 as the target image density and automatically performs image quality maintenance control according to the image self-check by the feedback control. Therefore, in the image forming apparatus according to the comparative example, in some case, image formation timing of the user and image quality maintenance control timing deviate from each other. For example, in a mass printing operation, in some case, the image density correction automatic execution timing comes while printing is performed in the image forming apparatus according to the comparative example.

After starting the mass printing of 300 sheets at timing v1 shown in FIG. 17, the image forming apparatus according to the comparative example performs the image quality maintenance control at image density correction automatic execution timing t2 and controls the image density by the image forming apparatus according to the comparative example from image density D4 to the target image density at factory shipment D1. The image forming apparatus according to the comparative example completes the mass printing of 300 sheets at timing v4 before image density correction automatic execution timing t3. Therefore, before and after image density correction automatic execution timing t2, in some case, an image formed by the image forming apparatus according to the comparative example suddenly changes. It is likely that, while the same prints is output on 300 sheets, an image suddenly changes, for example, a color changes and stable image quality cannot be obtained.

According to the embodiment, in order to obtain a desired image of the user, the MFP 100 changes the target image density for the image quality maintenance control from the target value at factory shipment to the user target value set by the user. The MFP 100 acquires image quality suitable for purposes of use of users and close to desired image quality of the users. Since the MFP 100 performs the image quality maintenance control according to the expected correction control, the MFP 100 reduces waiting time of the user for the image quality maintenance control. The MFP 100 sets a limit for a correction amount of a parameter used for the calculation of the expected correction control and gently performs the expected correction control. The MFP 100 suppresses, for example, a change in color of an image in the same print as much as possible.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. An image forming apparatus comprising:
an image forming section configured to form a toner image on an image bearing member; and
a first control section configured to change an image target value of the image forming section.

2. The apparatus according to claim 1, wherein the first control section changes the image target value to a new target value for reproducing an image selected by a user.

3. The apparatus according to claim 1, wherein a user selects necessity of a change of the image target value by the first control section on the basis of a trial image printed by the image forming section.

4. The apparatus according to claim 1, further comprising:
a detecting section configured to detect a test pattern formed by the image forming section; and
a second control section configured to control the image forming section on the basis of a detection result of the detecting section, wherein
the second control section subjects a difference between the detection result of the detecting section and the image target value to expected correction control.

5. The apparatus according to claim 4, wherein
the detecting section detects a new test pattern formed by the image forming section on the basis of a new target value changed by the first control section, and
the second control section subjects a difference between a detection result of the new test pattern of the detecting section and the new target value to the expected correction control.

6. The apparatus according to claim 4, wherein the second control section performs the expected correction control stepwise.

7. The apparatus according to claim 4, wherein the test-pattern forming section forms the new test pattern at a paper interval of printing by the image forming section.

8. The apparatus according to claim 1, wherein, after changing the image target value to a new target value, if printing operation by the image forming section is ended, the first control section returns the image target value to a reference value.

9. The apparatus according to claim 1, wherein, after changing the image target value to anew target value, the first control section stores the new target value in a memory.

10. The apparatus according to claim 9, wherein the first control section sets the image target value of the image forming section to the new target value called from the memory.

11. The apparatus according to claim 10, wherein the first control section calls, if authentication of a user is successful, the new target value concerning the user from the memory.

12. An image control method comprising:
setting a reference value as an image target value and controlling an image forming section;
changing the image target value to a new target value; and
setting the new target value as the image target value and controlling the image forming section.

13. The method according to claim 12, wherein the new target value is a target value for reproducing an image selected by a user.

14. The method according to claim 12, wherein a user selects on the basis of a trial image printed by the image forming section whether the image target value is changed to the new target value.

15. The method according to claim 12, further comprising subjecting a difference between a detection result of a test pattern formed by the image forming section and the new target value to expected correction control and controlling the image forming section.

16. The method according to claim 15, further comprising performing the expected correction control stepwise.

17. The method according to claim 15, further comprising performing the expected correction control at a break of printing operation.

18. The method according to claim 12, further comprising, after changing the image target value to the new target value, if printing operation is ended, returning the image target value to a reference value.

19. The method according to claim 12, further comprising storing the new target value in a memory.

20. The method according to claim 19, further comprising calling, if authentication of a user is successful, the new target value concerning the user from the memory.
